(19) United States
(12) Patent Application Publication
(10) Pub. No.: US 2022/0351264 A1
(43) Pub. Date: Nov. 3, 2022

(54) Financial Service Providing Method and Electronic Apparatus Performing the Same

(71) Applicant: Coupang Corp., Seoul (KR)

(72) Inventors: Wan Su Yang, Seoul (KR); Ho Hyun Lim, Seoul (KR)

(73) Assignee: Coupang Corp., Seoul (KR)

(21) Appl. No.: 17/387,556

(22) Filed: Jul. 28, 2021

(30) Foreign Application Priority Data
Apr. 28, 2021 (KR) 10-2021-0055017

(51) Int. Cl. G06Q 30/06; G06Q 30/02; G06Q 40/06; G06Q 20/40

(52) U.S. Cl. CPC G06Q 30/0609; G06Q 30/0641; G06Q 30/0206; G06Q 40/06; G06Q 20/403; G06Q 20/401

(57) ABSTRACT

Provided is a financial service providing method of an electronic apparatus comprising checking whether a financial service is available for a user based on the user's first sales information, checking a condition of use of the financial service for the user based on the user's second sales information, providing information on whether the financial service is available and the condition of use to an external apparatus, providing unsettled sales information of the user based on an information request from the external apparatus, and changing payment account information of a sales price to be paid to the user based on receiving information related to approval of providing the financial service from the external apparatus. Other example embodiments are also possible.

### TECHNICAL FIELD

Example embodiments of the present disclosure relate to a financial service providing method and an electronic apparatus performing the same.

### DESCRIPTION OF THE RELATED ART

With the development of Internet technology and the spread of portable terminals such as smartphones and tablet PCs, the e-commerce market is commercialized. In particular, in recent years, the proportion of users (consumers, buyers) directly visiting offline stores to purchase items has decreased due to the spread of infectious diseases, while the proportion of purchasing items online in the e-commerce market using PCs or mobile terminals is gradually increasing. In addition, according to such an active trend of the e-commerce market, the need for a trading brokerage service that mediates the trading between sellers and buyers is increasing.

The intermediary that provides the trading brokerage service plays the role of providing (promoting) the information related to seller's items to the buyer through a platform related to the e-commerce and ensuring that transactions can be made safely between the buyer and the seller, and can obtain a predetermined fee based on this.

For example, the buyer pays the payment price for the item to purchase to the intermediary, and the seller can deliver (ship) the item to the buyer according to information on the payment occurrence from the buyer. If it is confirmed that the item has been safely delivered from the seller to the buyer, the intermediary can pay the seller the sales price (settlement price) deducting the trading brokerage fee.

However, in the case of online trading in this way, during the period between the time when the buyer completes payment (or purchase confirmation) and the seller supplies the item to the buyer and the time when the seller receives the sales price, it is in the state that the seller has already provided the sale item, but the sales price has not been paid yet. Accordingly, difficulties may arise in the flow of fund management.

### DISCLOSURE OF THE INVENTION

### Technical Goals

An aspect of the present disclosure is to provide an electronic apparatus, which provides a trading brokerage service through a platform that sells items, providing a function of preventing the risk of money recovery from the perspective of providing financial services and improving the flow of money management of sellers by determining availability or conditions of use of financial services based on the seller's sales information.

### Technical Solutions

According to an aspect, there is provided a financial service providing method of an electronic apparatus including checking whether a financial service is available for a user based on the user's first sales information, checking a condition of use of the financial service for the user based on the user's second sales information, transmitting instruction information requesting provision of the financial service to an external apparatus based on a user input, and changing sales price payment account information of the user based on receiving information related to approval of the provision of the financial service from the external apparatus.

According to another aspect, there is also provided an electronic apparatus including a communication module, a database, and a processor electrically connected to the database, in which the processor is configured to check whether a financial service is available for a user based on the user's first sales information, check a condition of use of the financial service for the user based on the user's second sales information, transmit instruction information requesting provision of the financial service to an external apparatus based on a user input, and change sales price payment account information of the user based on receiving information related to approval of the provision of the financial service from the external apparatus.

### Effects

According to various example embodiments, it is possible to provide a function that prevents the risk of money recovery from the perspective of providing financial services and improves the flow of money management of sellers in an electronic apparatus providing a trading brokerage service by determining availability or conditions of use of financial services based on the seller's sales information in the electronic apparatus or by providing the seller's sales information to a financial service providing server for provision of predetermined financial services.

In particular, it is possible to provide more stable financial services to sellers by providing information on whether or not financial services are provided by determining a situation in which the possibility of collecting money is lowered according to the occurrence of a specific event.

### BRIEF DESCRIPTION OF THE DRAWINGS

FIG. 1 is a schematic diagram illustrating a financial service providing system according to various example embodiments of the present disclosure.

FIG. 2 is a schematic block diagram of an electronic apparatus according to an example embodiment of the present disclosure.

FIG. 3 is a flowchart illustrating a financial service providing method of an electronic apparatus according to an example embodiment of the present disclosure.

FIG. 4 is a schematic flowchart of an operation of a financial service providing system according to an example embodiment of the present disclosure.

FIG. 5 is a schematic flowchart of an operation of a financial service providing system according to an example embodiment of the present disclosure.

FIG. 6 is a schematic flowchart of an operation of a financial service providing system according to an example embodiment of the present disclosure.

### DETAILED DESCRIPTION FOR CARRYING OUT THE INVENTION

The terms used in the example embodiments have been selected as general terms that are currently widely used as possible while taking functions in the present disclosure into consideration, but these may vary according to the intention of those skilled in the art, a precedent, the emergence of new technologies, and the like. In addition, in certain cases, there are terms arbitrarily selected by the applicant, and in this case, the meaning will be described in detail in the corresponding description. Therefore, the terms used in the present disclosure should be defined based on the meaning of the term and the whole contents of the present disclosure, not just the name of the term.

Throughout the specification, when it is stated that a part “includes” or “comprises” a certain component, it means that other components may be further included, and it does not preclude other components, unless otherwise stated. In addition, terms such as “ . . . unit”, “ . . . module” described in the specification mean a unit for performing at least one function or operation, which may be implemented as hardware or software, or as a combination of hardware and software.

Throughout the specification, expression “at least one of a, b, and c” may include ‘a only’, ‘b only’, ‘c only’, ‘a and b’, ‘a and c’, ‘b and c’, or ‘all of a, b, and c’.

The “terminal” mentioned below may be implemented as a computer or a portable terminal that can access a server or other terminal through a network. Here, the computer includes, for example, a notebook, a desktop, a laptop, and the like, equipped with a web browser, and the portable terminal is, for example, a wireless communication device that guarantees portability and mobility, which may include all kinds of handheld-based wireless communication device including communication-based terminals such as IMT (International Mobile Telecommunication), CDMA (Code Division Multiple Access), W-CDMA (W-Code Division Multiple Access), LTE (Long Term Evolution), smartphones, tablet PCs, or the like.

Example embodiments of the present disclosure will be described in detail with reference to the accompanying drawings so that those skilled in the art may easily implement the present disclosure. However, the present disclosure may be implemented in various different forms and is not limited to the example embodiments described herein.

Example embodiments of the present disclosure are described in detail with reference to the accompanying drawings.

Detailed descriptions of technical specifications well-known in the art and unrelated directly to the present disclosure may be omitted to avoid obscuring the subject matter of the present disclosure. This aims to omit unnecessary description so as to make clear the subject matter of the present disclosure.

For the same reason, some elements are exaggerated, omitted, or simplified in the drawings and, in practice, the elements may have sizes and/or shapes different from those shown in the drawings. Throughout the drawings, the same or equivalent parts are indicated by the same reference numbers

Advantages and features of the present disclosure and methods of accomplishing the same may be understood more readily by reference to the following detailed description of example embodiments and the accompanying drawings. The present disclosure may, however, be embodied in many different forms and should not be construed as being limited to the example embodiments set forth herein. Rather, these example embodiments are provided so that this disclosure will be thorough and complete and will fully convey the concept of the disclosure to those skilled in the art, and the present disclosure will only be defined by the appended claims. Like reference numerals refer to like elements throughout the specification.

It will be understood that each block of the flowcharts and/or block diagrams, and combinations of blocks in the flowcharts and/or block diagrams, can be implemented by computer program instructions. These computer program instructions may be provided to a processor of a general-purpose computer, special purpose computer, or other programmable data processing apparatus, such that the instructions which are executed via the processor of the computer or other programmable data processing apparatus create means for implementing the functions/acts specified in the flowcharts and/or block diagrams. These computer program instructions may also be stored in a non-transitory computer-readable memory that can direct a computer or other programmable data processing apparatus to function in a particular manner, such that the instructions stored in the non-transitory computer-readable memory produce articles of manufacture embedding instruction means which implement the function/act specified in the flowcharts and/or block diagrams. The computer program instructions may also be loaded onto a computer or other programmable data processing apparatus to cause a series of operational steps to be performed on the computer or other programmable apparatus to produce a computer implemented process such that the instructions which are executed on the computer or other programmable apparatus provide steps for implementing the functions/acts specified in the flowcharts and/or block diagrams.

Furthermore, the respective block diagrams may illustrate parts of modules, segments, or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions.

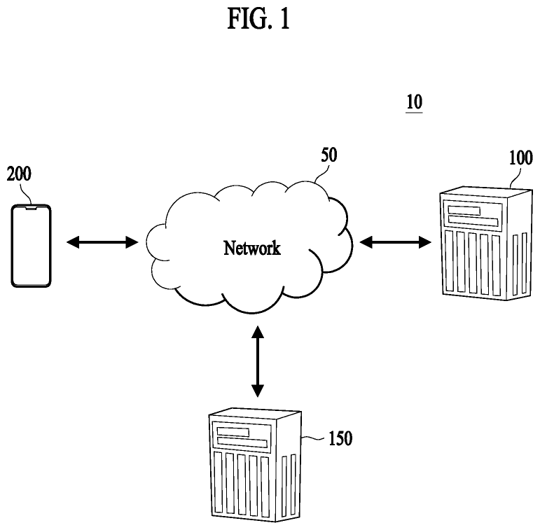

FIG. 1 is a schematic diagram illustrating a financial service providing system according to various example embodiments of the present disclosure.

A financial service providing system 10 according to various example embodiments may include at least one of an electronic apparatus (a first electronic apparatus) 100, an external apparatus (a second electronic apparatus) 150, and a user terminal 200, which are connected via network 50.

According to various example embodiments, the electronic apparatus 100 is an apparatus that performs a series of functional processing for providing various pieces of information related to item sales in e-commerce. It may perform set operations based on a user input received from the user terminal 200 through the network 50 and provide the user terminal 200 with information corresponding thereto.

For example, the electronic apparatus (e.g., trading brokerage service providing server) 100 may include a plurality of computer systems or computer software implemented as a network server. For example, the electronic apparatus 100 may refer to a computer system and computer software that is connected to a lower-level apparatus capable of communicating with another network server through a computer network such as an intranet or the Internet to receive a request to perform a task, perform a task on it, and provide a result of the task. In addition, it can be understood as a broad concept including a series of application programs that can operate on a network server and various databases built therein. For example, the electronic apparatus 100 may be implemented using a network server program variously provided according to an operating system such as DOS, Windows, Linux, UNIX, MacOS, or the like.

According to various example embodiments, the electronic apparatus 100 may process information related to item sales in e-commerce, store or manage related data in a database, and check information related to the provision of financial services based on the sales-related information of the item (e.g., sales-related information of the item of which purchase is confirmed). For example, the electronic apparatus 100 determines whether to allow a user to use a predetermined financial service based on the information related to item sales of a specific user (seller), thereby minimizing the risk of money recovery due to the provision of financial services.

For example, the electronic apparatus 100 may check whether a user is eligible for a financial service based on the user's first sales information including at least one of the user's sales history information (e.g., existing sales period information, existing sales figures information, information on the number of existing sale items, buyer's evaluation information on existing sale items, etc.), and attribute information of the sale item (e.g., whether the sale item is an unstructured item (e.g., admission ticket, accommodation voucher, etc.), whether the sale item is a currency item (e.g., pure gold, gift certificate, etc.), whether it is a pre-order item, whether it is an item related to a category corresponding to the occurrence of other events).

For example, the electronic apparatus 100 may check the user's conditions of use of a financial service based on the user's second sales information including at least one of category information of the user's sale item and the user's sales figures information (e.g., amount information of unsettled sales figures and payment schedule information). In addition, the electronic apparatus 100 may check the user's eligibility and conditions of use for the financial service based on the user's financial service use history information or the user's credit information.

Moreover, upon receiving result information of approving the use of the financial service from the external apparatus 150 (e.g., a financial service providing server), the electronic apparatus 100 may change and provide payment account information of the sales price to be settled to the user.

For example, the financial service may include a service in which the electronic apparatus 100 changes a payment schedule for at least a portion of the unsettled sales price to be paid to the user and the external apparatus 150 provides it to the user on behalf of the electronic apparatus 100. For example, the external apparatus 150 may generate instruction information for paying at least a portion of the sales price to a financial account corresponding to the user on a schedule prior to the preset settlement schedule of the sales price, and the electronic apparatus 100 may generate instruction information for paying at least a portion of the sales price to a virtual financial account corresponding to the external apparatus 150 according to an existing settlement schedule.

As another example, the financial service may include a service that provides an event that allows the use of a card corresponding to a sales price to be provided to the user. For example, the user using the financial service can make a payment, such as purchasing an item within the limit corresponding to the unsettled sales price, using a set card even before the payment schedule of the unsettled sales price arrives. In order to pay the card price according to the existing payment schedule, the electronic apparatus 100 may generate instruction information for paying at least a portion of the sales price as the card price to the virtual financial account corresponding to the external apparatus 150.

According to another example embodiment, the electronic apparatus 100 may correspond to a server that provides an intermediary service among a delivery agency that provides a delivery service of an item to a purchaser on behalf of a seller, the seller, and the purchaser. The electronic apparatus 100 may provide a financial service capable of variably providing a payment schedule of the delivery service fee in connection with the external apparatus 150 in relation to the payment of the delivery service fee to be paid to the delivery agency. For example, the electronic apparatus 100 (or the external apparatus 150) may determine the eligibility for the financial service and conditions of use (e.g., interest rates, fees, limits, conditions related to period, etc.) based on the delivery performance information (e.g., delivery count information, delivery frequency information, delivery area information, and/or delivery evaluation information) of the delivery agency and may provide a function to change financial account information to pay the delivery service fee, if needed.

According to an example embodiment, in order to provide the seller with the financial service to change and provide the payment schedule of the sales price, the electronic apparatus 100 may be provided with sales figures information of the seller (e.g., sales amount information for a predetermined period, purchaser payment information corresponding to each sale, etc.) from the seller's POS (point of sales) apparatus (e.g., a POS terminal). In an example embodiment, the POS apparatus may receive input information of applying for use of the financial service from the seller, and transmit information related thereto (e.g., at least one of seller identification information, sales figures information, and financial service use application condition information) to the electronic apparatus 100. The electronic apparatus 100 may perform a procedure for providing the financial service to the seller in connection with the external apparatus 150 based on the information received from the POS apparatus. Meanwhile, in another example embodiment, the POS apparatus may directly perform a function of providing the financial service of the electronic apparatus 100 according to various example embodiments of the present disclosure. For example, the POS apparatus may provide the financial service to the seller by interworking with the external apparatus 150 as it accumulatively acquires the sales figures information of the seller and receives the input information of applying for use of the financial service from the seller. In this way, the seller can easily apply for the financial service using the apparatus (e.g., the POS apparatus, the electronic apparatus 100) that collects and manages item sales-related information (e.g., sales figures information, etc.) through online or offline and can be easily provided with the financial service according to various example embodiments of the present disclosure.

Meanwhile, each of the electronic apparatus 100 and the external apparatus 150 may function as a front-end server providing various pieces of information related to item sales and/or various pieces of information related to the provision of financial services in the form of a user interface displayed through a web page or an application installed on the user terminal 200. However, this is only an exemplary description, and it may also be implemented to transmit related information to a separate front-end server and provide data related to a display screen from the front-end server to the user terminal 200.

The network 50 may serve to connect the electronic apparatus 100 and the user terminal 200, or the electronic apparatus 100 and the external apparatus 150. For example, the network 50 may provide an access path so that the user terminal 200 or an external apparatus may be connected to the electronic apparatus 100 to transmit and receive packet data. For example, the user terminal 200 may be connected to the electronic apparatus 100 or the external apparatus 150 through the network 50 to transmit and receive at least one of item sales-related information for implementing an e-commerce and information related to the provision of financial services.

The electronic apparatus 100 may store information received from the user terminal 200 or another external apparatus in a database, or transmit information stored in the database to the user terminal 200 or the external apparatus 150.

Meanwhile, in an example embodiment, at least some functions that can be processed by the electronic apparatus 100 or the external apparatus 150 may also be implemented through the user terminal 200. For example, a user may receive an information providing system-related program of an application type through the network 50 to install and use it in the user terminal 200, and the application-type program may perform at least some functions processed by the electronic apparatus 100 to be described later.

The financial service providing system 10 according to various example embodiments may be implemented as a single physical apparatus, or may be implemented in a manner in which a plurality of physical apparatuses are organically combined. For example, some of the functions provided by the electronic apparatus 100 may be implemented by any one physical apparatus (e.g., the external apparatus 150, the user terminal 200, or other apparatuses) and some of the functions may be implemented by another physical apparatus. For example, one physical apparatus may be implemented as a part of the electronic apparatus 100, and another physical device may be implemented as a part of the user terminal 200 or a part of other external apparatus. In some cases, each component included in the financial service providing system 10 is distributed and arranged in different physical apparatuses, and the distributed components are organically combined to be implemented to perform functions and operations of the financial service providing system 10 of the present disclosure.

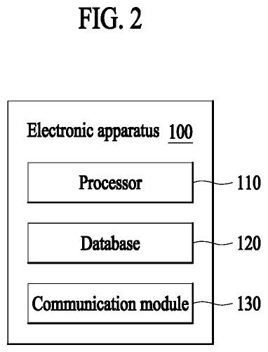

FIG. 2 is a schematic block diagram of an electronic apparatus according to an example embodiment of the present disclosure.

Referring to FIG. 2, the electronic apparatus 100 (e.g., a trading brokerage service providing server) according to various example embodiments may include at least one of a processor 110, a database 120, and a communication module 130.

The electronic apparatus 100 may correspond to an apparatus that provides information related to an e-commerce service. For example, the electronic apparatus 100 may obtain predetermined item sales-related information from the user (seller) through the user terminal (seller terminal) 200 and process the item sales-related information to be checked on a purchaser terminal. The electronic apparatus 100 may broker a purchase so that a purchaser can purchase a predetermined item sold by a seller based on a purchase request input (and a payment input) received from a specific purchaser terminal.

The electronic apparatus 100 may store and manage the item sales-related information. For example, the electronic apparatus 100 may check and manage the sales information of an unsettled item for which a sale has been completed by a specific purchaser, but the settlement for the corresponding sale item has not yet been completed on the electronic apparatus 100. For example, when checking the sales information of the item that needs to be settled, the electronic apparatus 100 may check only the sales information on the item for which the purchase has been confirmed based on whether the purchase has been confirmed by the purchaser.

For example, when it is determined that a set period (e.g., N days (e.g., 7 days) after the purchase date) has elapsed after an item has been purchased from a specific purchaser, the electronic apparatus 100 may automatically confirm the purchase. Even before the set period has elapsed, the purchase may be immediately confirmed upon receiving input information of confirming the purchase from the purchaser. In addition, when an exchange request is received after purchase of the item, the electronic apparatus 100 may determine the purchase confirmation time based on a time when the exchange process is completed.

The electronic apparatus 100 may map information on the item for which the purchase confirmation has been completed, for example, at least one of sales price information of the corresponding item, attribute information of the item, and evaluation information of the purchaser after purchase confirmation, with user (seller) information to store in the database 120 of the electronic apparatus 100. In addition, the electronic apparatus 100 may manage information related to a settlement schedule for each item for which purchase confirmation has been completed as well and store them in the database 120. For example, even when payment or purchase of a specific item is completed, the electronic apparatus 100 may set to pay the sales price after a predetermined elapsed date rather than immediately paying to the user (seller) considering the possibility that a return request or a refund request of the item may occur from the purchaser.

For example, the settlement schedule of the sales price corresponding to the items for which purchase confirmation has been completed for one month may be set after 15 business days from the last day of each month. For another example, the above settlement schedule may be set for the sales price corresponding to some ratio (e.g., 70%) on a weekly basis and for the sales price for the remaining ratio (e.g., 30%) on a monthly basis so that the sales price can be paid to the user (seller) on a schedule as quickly as possible except for the minimum required amount in consideration of the possibility of a return or refund request. For example, a user (seller) may select a settlement type for each sale item, and the electronic apparatus 100 may store and manage information related to a settlement schedule (payment schedule) according to the settlement type selected by the user (seller).

The processor 110 may process various functions for performing a trading brokerage service or financial service providing method according to various example embodiments of the present disclosure, and may be electrically connected with other components of the electronic apparatus 100 (e.g., the database 120, the communication module 130) to control the overall operation of the components.

For example, the processor 110 may provide information on a sale item registered by a user (seller) to at least one purchaser terminal, and, when a specific item is purchased from the purchaser terminal and payment and purchase confirmation are completed, the sales information of the corresponding item may be stored and managed in the database 120 together with the settlement schedule information of the item as unsettled sales information.

The processor 110 may check whether the user is eligible for a specific financial service based on at least part of the user's sales-related information (the first sales information). In addition, the processor 110 may check the user's financial service use condition information based on at least part of the user's sales-related information (the second sales information).

The processor 110 may use the communication module 130 to provide information on the eligibility and conditions of use for the financial service to the external apparatus 150 (e.g., a financial service providing server).

In addition, the processor 110 may provide the user's unsettled sales information to the external apparatus 150 using the communication module 130. The processor 110 may provide the user's unsettled sales information to the external apparatus 150 based on a user request related to the provision of the financial service, or may repeatedly update the user's unsettled sales information at each preset time period and provide them to the external apparatus 150. For example, the operation of providing the unsettled sales information may be performed only when it is determined that the user is eligible for the financial service.

The processor 110 may change payment account information for at least a portion of the sales price set to be paid to the user based on receiving information for approving the provision of the financial service from the communication module 130. For example, the operation of changing the payment account information may be executed in response to the external apparatus 150 providing the financial service for at least a portion of the sales price to the user. For example, the processor 110 may change the payment account information to a virtual financial account corresponding to the external apparatus 150 that provides the financial service to the user.

In addition, the processor 110 may implement various functions related to provision of information according to various example embodiments of the present disclosure to be described later.

The database 120 is a data structure implemented in a predetermined storage space of the electronic apparatus 100, and functions such as storing, searching, deleting, editing, or adding data may be freely performed. For example, the database 120 may have fields or elements for processing functions such as storing, searching, deleting, editing, or adding data.

The database 120 may store data related to various functions of the electronic apparatus 100. For example, the database 120 may store various types of data related to a service providing method according to various example embodiments of the present disclosure, and may store instructions or data for an execution operation of the processor 110.

The communication module 130 may perform functions of transmitting information stored in the database 120 of the electronic apparatus 100 or predetermined information processed by the processor 110 to another apparatus (e.g., the external server 150, the user terminal 200, or another external apparatus), or receiving information from another apparatus to the electronic apparatus 100. For example, the communication module 130 may receive predetermined user input information from the user terminal 200 and various pieces of information from the external server 150. For example, the communication module 130 may include a transceiver for transmitting and receiving information.

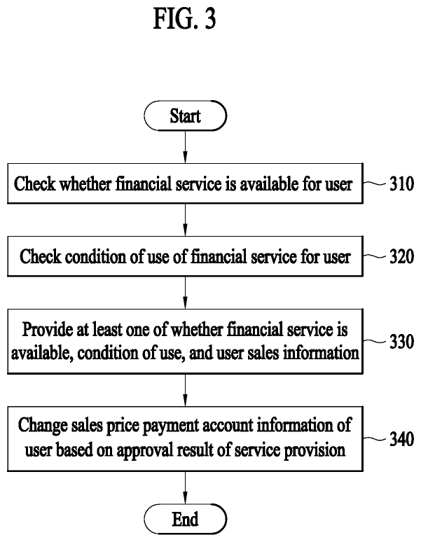

FIG. 3 is a flowchart illustrating a financial service providing method of an electronic apparatus according to an example embodiment of the present disclosure.

Referring to FIG. 3, the method of providing a financial service according to an example embodiment may include checking whether a financial service is available for a user by the electronic apparatus 100 (e.g., the processor 110) in operation 310.

The electronic apparatus 100 is an apparatus that provides an item sales service for e-commerce, and may collect sales-related information on items sold by a specific user, and store and manage the information in correspondence with user information. Also, the electronic apparatus 100 may identify, based on receiving an input requesting predetermined information related to the financial service from the user, the sales-related information corresponding to the user.

For example, at least one of the external apparatus 150 (e.g., a financial service providing server) and the electronic apparatus 100 (e.g., a trading brokerage service providing server) may provide the user (seller) with a user interface for introducing a specific financial service through the user terminal 200 and receive a user input for requesting financial service-related information from the user. For example, when receiving the user's request input information, the external apparatus 150 may request the electronic apparatus 100 to check the financial service-related information in relation to the user (e.g., whether the financial service is available for the user and, if available, information on conditions of use). The electronic apparatus 100 may then perform operation 310 according to the request input from the external apparatus 150. As another example, the electronic apparatus 100 may directly receive the user request input information from the user (the user terminal 200) and perform operation 310.

In operation 310, the electronic apparatus 100 may check whether the user can use the financial service. In particular, the electronic apparatus 100 may identify whether the user is eligible for the financial service based on at least part of the user's sales-related information (the first sales information).

For example, based on the user's sales period information, if the period during which the user continued to sell through the sales service provided by the electronic apparatus 100 is less than a specified period (e.g., if the user's sales period is less than 3 months),the electronic apparatus 100 may determine that the user cannot use the financial service. For example, based on the user's existing sales figures information, when the average sales amount of the user for the last predetermined period is less than a specified value (e.g., if the average sales figures for the last two months do not exceed 2 million won per month), the user may be determined not to be eligible for the financial service. As another example, the electronic apparatus 100 may determine whether the financial service is available based on information on the quantity of items sold by the user or information on evaluation of purchasers for items sold by the user. As described above, the electronic apparatus 100 may determine that the user is a reliable seller and can use the financial service when the user has continuously sold a specific item for a long period of time or when steady sales of a predetermined amount or more for various items are confirmed.

According to an example embodiment, the electronic apparatus 100 may check whether the user can use a financial service based on attribute information of an item sold by the user. For example, when items sold by the user are unstructured items such as admission tickets or lodging vouchers, currency items such as pure gold or gift certificates, or pre-order items, the electronic apparatus 100 may determine that the user may not use the financial service.

According to an example embodiment, the electronic apparatus 100 may determine whether the user is eligible for the financial service based on whether the category of the user's sale item corresponds to an occurrence of a specific event. For example, based on the return rate information for at least one item belonging to the category of the sale item, when the return rate for items of a specific category exceeds a threshold value or increases rapidly within a short period of time, the electronic apparatus 100 may restrict the use of the financial service to the user who sell items belonging to the corresponding category. As another example, based on information on use history information of the financial service of other users selling items of a specific category, when the situation where the rate of money recovery related to the financial service by other sellers selling related items is lower than the set value is detected, the electronic apparatus 100 may limit the use of the financial service by the user who sells the items belonging to the corresponding category. The electronic apparatus 100 may secure stability related to service provision in this manner by limiting the use of the financial service of the user who sells an item that is generally classified as an item with a low risk of collecting money but with a rapid increase in the risk of collecting money due to the occurrence of a specific event (e.g., the return rate increases rapidly in bedding as radon is detected, etc.).

Next, in operation 320, the electronic apparatus 100 (e.g., the processor 110) may check financial service use condition information corresponding to the user based on at least part of the user's sales-related information, for example, the second sales information.

For example, the electronic apparatus 100 may check the financial service use condition information based on at least one of the user's sale item category information and the user's sales figures information as the second sales information. For example, the electronic apparatus 100 may check the sales information corresponding to the unsettled portion of the user's sales figures information, and, based on these, determine the condition for the use limit of the financial service (e.g., the payment limit of unsettled sales price). For example, based on the category information of the sale item, the electronic apparatus 100 may check a preset interest rate (or fee) condition or payment limit condition (e.g., 70% or 90% of the unsettled sales price is set as the limit for the use of the financial service depending on the item category) for each category. The electronic apparatus 100 may provide a favorable interest rate condition or a high rate of use limit (e.g., 90% or 100% of the unsettled sales price is set as the limit for the use of the financial service) to the user, when the purchaser's evaluation information for the item sold by the user is excellent, or when the average sales figures of the user is greater than or equal to a set value, as the user's sales history information. According to some example embodiments, if the user's credibility is judged to be high based on the sales-related information, the electronic apparatus 100 (or the external apparatus 150) may determine the use limit rate condition to exceed 100% (e.g., 120% of the unsettled sales price is paid in advance to the user).

The financial service use condition information checked by the electronic apparatus 100 in operation 320 may include at least one of a condition related to a financial service provision schedule (e.g., a payment schedule for unsettled sales price), a condition related to a financial service provision limit (e.g., payment limit amount of unsettled sales price), or a condition related to an interest rate (or fee) applied when the financial service is provided.

On the other hand, in operation 330, the electronic apparatus 100 (e.g., the processor 110), may provide to the outside with at least one of the information on the availability of the financial service of the user, the information on the conditions of use of the financial service, and the user's sales-related information, checked in operations 310 and 320.

For example, in response to a request for information from the external apparatus 150 (for example, a financial service providing server), the electronic apparatus 100 may provide at least one of the above-described information on the availability of the financial service, information on the conditions of use, and the sales-related information. Here, the user's sales-related information provided by the electronic apparatus 100 to the external apparatus 150 may include information on the outstanding sales price that has not yet been settled (e.g., unsettled sales price, information on payment account to pay the sales price, sales price payment schedule, etc.).

Meanwhile, according to an example embodiment, the electronic apparatus 100 may provide at least some of the sales-related information that can be used for checking in operations 310 and 320 among the user's sales-related information, that is, information on at least some of the first sales information and the second sales information, instead of the information related to the check results in operations 310 and 320, or it may also provide other user identification information (e.g., a business registration number corresponding to the user, etc.). The external apparatus 150 may determine whether to finally approve to provide the financial service to the user based on the received information.

Next, in operation 340, the electronic apparatus 100 may receive result information regarding the approval of the provision of the financial service from the external apparatus 150, and may change the payment account information of the sales price to be paid to the user based on the result of approval of the provision of the financial service.

For example, upon receiving the result information indicating that the provision of the financial service to the user has been approved from the external apparatus 150, based on the execution of the financial service in the external apparatus 150, the electronic apparatus 100 may change the sales price payment account of the user.

For example, the financial service provided to the user in connection with the external apparatus 150 may include a service to change the payment schedule of the sales price (sale settlement amount) provided to the user according to the item sale of the user (seller) in the e-commerce system.

For example, the electronic apparatus 100 may store the user's sales price payment account information set in advance in response to the user's item sales in the database 120. If the financial service has not been requested from the user or the financial service is not approved by the external apparatus 150, related instruction information may be generated to pay the sales price to be settled to the user to a designated financial account (an account for paying unsettled sales price) according to an existing designated payment schedule.

On the other hand, when the financial service is requested by the user and the service provision is approved from the external apparatus 150, the electronic apparatus 100 may provide the external apparatus 150 with instruction information to pay at least a portion of the sales price to be settled to the user, according to the changed payment schedule, to the financial account (sales price payment account). In addition, according to the approval of the provision of the financial service from the external apparatus 150, the electronic apparatus 100 may change the existing financial account (sales price payment account) that was set to pay the unsettled sales price to be paid to the user to a virtual financial account corresponding to the external apparatus 150. Also, instruction information to pay at least a portion of the sales price to be settled to the user, according to the payment schedule before the change, to the changed virtual financial account (sales price payment account) corresponding to the external apparatus 150 may be generated.

For example, the external apparatus 150 may generate instruction information for pre-paying at least a portion of the sales price to the user on a schedule earlier than the payment schedule of the sales price to be settled to the user, and then be provided with the at least a portion of the sales price from the electronic apparatus 100 through the virtual financial account corresponding to the external apparatus 150 according to the existing payment schedule. For example, the external apparatus 150 may receive, based on the financial service use conditions (e.g., interest rate condition) checked in operations 320 and 330, instruction information to provide the user with at least a portion of the sales price in which the interest amount corresponding to the change in the payment schedule has been reduced.

For example, the external apparatus 150 may generate instruction information to provide at least a portion of the sales price on a schedule later than the payment schedule of the sales price set in advance to be settled to the user. Even in this case, the electronic apparatus 100 may provide the at least a portion of the sales price to the virtual financial account of the external apparatus 150 according to an existing payment schedule set to be paid to the user. For example, the external apparatus 150 may receive instruction information for providing the user with at least a portion of the sales price with an increased interest corresponding to the change in the payment schedule of the sales price.

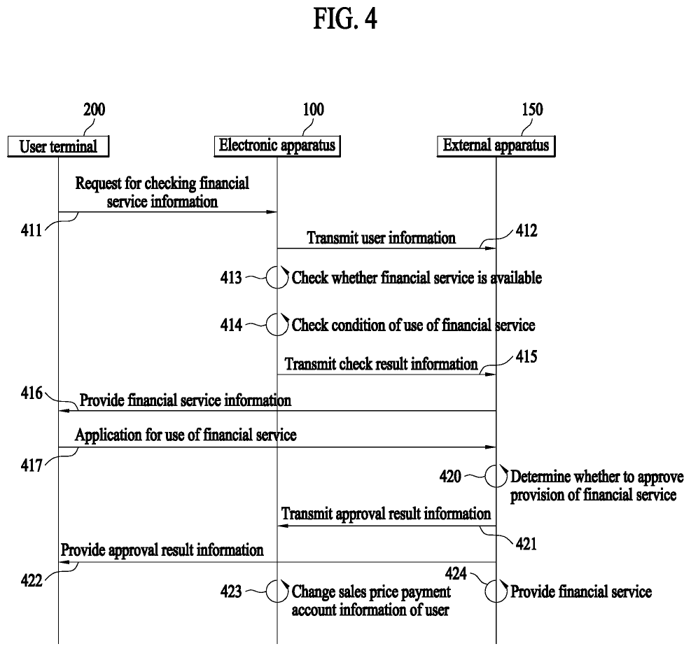

FIGS. 4 to 6 are flowcharts of financial service providing methods according to various example embodiments of the present disclosure.

Referring to FIG. 4, in a method of providing a financial service according to an example embodiment, input information requesting check of financial service information for a user may be transmitted from a user terminal 200 (e.g., a seller terminal) to an external apparatus 150 (e.g., a financial service providing server) in operation 411.

The external apparatus 150 may determine whether the input information requesting check of the financial service information is received from the user terminal 200, and may perform operation 412 upon receiving the check request.

For example, the external apparatus 150 may receive user information (e.g., user identification information, user subscription information, or business registration number corresponding to the user) from the user terminal 200 in operation 411, and transmit the user information to the electronic apparatus 100 (e.g., a sales service providing server), in operation 412, to request to check financial service-related information corresponding to the user.

In operation 413, the electronic apparatus 100 may check whether a financial service is available for the user corresponding to the user information. For example, the electronic apparatus 100 may check the first sales information corresponding to the user and determine whether to provide the financial service to the user based on the first sales information. For example, the electronic apparatus 100 may check at least some of information on existing sales history of the user (e.g., sales period, average sales figures, number of items sold, etc.), attribute information of items sold by the user (e.g., currency items, unstructured items, pre-order items, etc.), or predetermined information about the category of the items sold by the user (e.g., return rate information of the item(s) belonging to the category of the items sold, use history information of financial service of other users selling the item(s), etc.), as the first sales information, and it is possible to determine whether or not the financial service is available based on at least part of these information. In addition, based on the user's existing financial service use history information, if the user has previously used the financial service but failed to recover money in relation to the financial service, the electronic apparatus 100 may restrict the use of the financial service of the user.

In operation 414, the electronic apparatus 100 may check financial service use conditions of the user corresponding to the user information. For example, the electronic apparatus 100 may check the second sales information corresponding to the user, and check financial service provision conditions for the user based on the second sales information. For example, operation 414 may be executed only when the electronic apparatus 100 determines that the user can use the financial service in operation 413.

For example, the electronic apparatus 100 may check at least some of the category information (e.g., clothing category, bedding category, food and beverage category, furniture category, etc.) of the sale items and the user's sales figures information (e.g., sales figures information corresponding to unsettled sales price), as the second sales information, and, based on this, information on conditions that can be provided when the user uses the financial service (e.g., service use limit amount (e.g., limit rate on the service use limit amount relative to the actual unsettled sales price), service availability period, interest rate (money rate) conditions, etc.) may be checked. For example, if the user's sale item belongs to the first category, the first condition (e.g., the first interest rate condition, the first limit amount condition, and/or the first period condition) is applied when applying the financial service to the corresponding sale item. If the user's sales product belongs to the second category, the second condition (e.g., the second interest rate condition, the second limit amount condition, and/or the second period condition) is applied when applying the financial service to the corresponding sale item.

Meanwhile, the electronic apparatus 100 may determine the conditions of use of the financial service based on the user's existing sales figures information, or may determine the conditions of use of the financial service based on whether the user has subscribed to a specific sales-related membership. For example, based on the user's existing sales figures information, if the user makes consecutive sales figures more than a specified amount with a plurality of sale items, the electronic apparatus 100 may determine that the financial service is available under a relatively low interest rate. For another example, based on whether the user has subscribed to a specific sales-related membership service (e.g., a membership for providing a delivery service, a membership related to item promotion, a membership registered with an affiliate, etc.) provided by the electronic apparatus 100, the electronic apparatus 100 may check condition information for the user who has subscribed to the membership to use the financial service at a lower interest rate (or fee) condition.

In operation 415, the electronic apparatus 100 may transmit the user's eligibility for the financial service and check result information regarding the conditions of use of the financial service to the external apparatus 150. In addition, in operation 416, the external apparatus 150 may provide information on the financial service to the user terminal 200 based on the check result.

According to an example embodiment, the electronic apparatus 100 may also provide the user's sales information in operation 415. For example, the user's sales information provided from the electronic apparatus 100 to the external apparatus 150 may include unsettled sales information that has not been settled to the user from the electronic apparatus 100 side. The electronic apparatus 100 may provide, as the unsettled sales information, unsettled sales price information and payment schedule information corresponding to each unsettled sales price, to the external apparatus 150. The external apparatus 150 may directly determine at least some of the conditions of use of the financial service (e.g., a payment limit for using the service and conditions related to a payment schedule) according to the provided unsettled sales information.

Meanwhile, the electronic apparatus 100 may repeatedly perform operations 413 to 416 according to a specified time period. For example, the electronic apparatus 100 updates the user's sales information (e.g., the first sales information, second sales information, unsettled sales information, etc.) on a daily basis and check the availability and condition information of the financial service based on this to update the related information in the external apparatus 150 or the user terminal 200.

In operation 417, the external apparatus 150 may receive a user input requesting the use of the financial service from the user terminal 200.

In operation 420, the external apparatus 150 may determine whether to approve the provision of the financial service to the user based on the user input. For example, the external apparatus 150 may check the user's credit information based on the user identification information, and finally determine whether to provide the financial service according to information on whether the user is already using another type of financial service, and the like. For example, the external apparatus 150 may finally approve the financial service provision only in the case of application for use of the financial service in which financial service application conditions (e.g., service use request limit, etc.) included in the user input in operation 417 are within the scope of the financial service use conditions determined in operation 414.

In operations 421 and 422, the external apparatus 150 may transmit result information regarding approval for providing the financial service to the electronic apparatus 100 and the user terminal 200.

In operation 424, the external apparatus 150 may generate instruction information to provide the financial service to the user and execute a financial service providing operation.

In addition, in operation 423, the electronic apparatus 100 may change payment account information for at least a portion of the unsettled sales price to be paid to the user for which financial service provision has been requested.

In this regard, the electronic apparatus 100 may generate instruction information to pay at least a portion of the sales price to the changed payment account (a virtual sales price payment account corresponding to the external apparatus 150) according to a preset payment schedule. The external apparatus 150 may generate instruction information to pay at least a portion of the sales price to the user's payment account according to the changed payment schedule corresponding to the financial service application.

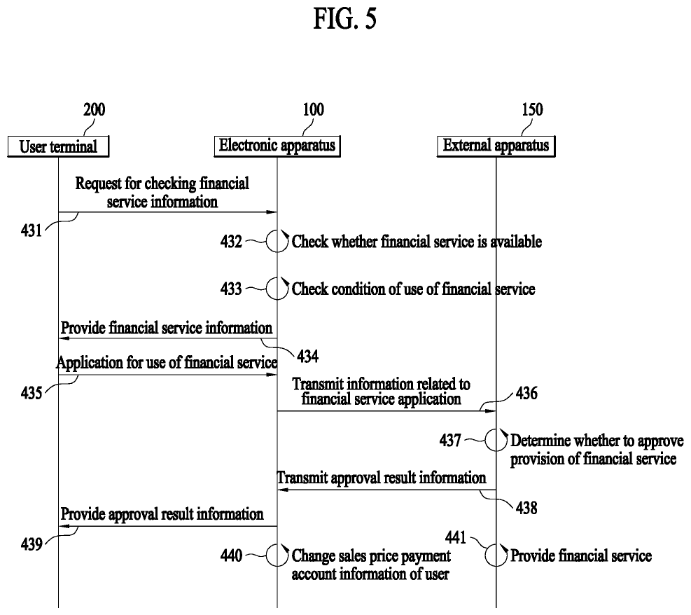

FIG. 5 is a flowchart of a financial service providing method according to another example embodiment of the present disclosure.

Referring to FIG. 5, in operation 431, the user terminal 200 may receive a user input requesting checking of financial service information, and provide the request information to the electronic apparatus 100 that provides an item sales-related service.

In operation 432, the electronic apparatus 100 may check information on whether a financial service is available for the user based on at least part of the user's sales information corresponding to the user terminal 200 (e.g., the first sales information). In operation 433, the information on the user's financial service use condition may be checked based on at least part of the user's sales information (e.g., the second sales information).

In operation 434, the electronic apparatus 100 may provide the user terminal 200 with information on whether the financial service is available and information on the conditions of use, based on the results checked in operations 432 and 433. In operation 435, an input of a financial service use application may be received from the user.

When it is determined in operation 436 that the application input from the user satisfies the use condition information (e.g., application limit, period, etc.) of the financial service, the electronic apparatus 100 may provide the external apparatus 150 with information related to the financial service application in response to the application input. For example, in operation 436, the electronic apparatus 100 may transmit at least some of whether the user's financial service is available, the conditions of use, the information related to the user's application, and the user's unsettled sales information to the external apparatus 150.

In operation 437, the external apparatus 150 may determine whether to approve the provision of the financial service based on at least some of the information received from the electronic apparatus 100, credit information corresponding to the user, and the user's existing financial service use history information. In operation 438, information on the approval result may be transmitted to the electronic apparatus 100. In addition to the information received from the electronic apparatus 100, the external apparatus 150 may determine whether to approve the use of the financial service based on separately managed credit-related information of the user.

In operation 439, the electronic apparatus 100 may transmit information on the received approval result to the user terminal 200. If it is determined that the provision of financial services is approved from the external apparatus 150, in operation 440, the electronic apparatus 100 may change the account information for payment of the sales price for at least a portion of the user's unsettled sales price. In operation 441, the external apparatus 150 may provide a predetermined financial service (e.g., a service for changing a sales price settlement schedule, etc.).

As shown in FIGS. 4 and 5, the method of providing a financial service according to an example embodiment may be performed in a manner of directly checking the information on the availability of the financial service and the condition of use of the financial service based on the user's sales-related information, which is managed and collected by the electronic apparatus 100 that provides an e-commerce sales service, transmitting the information related to application for the financial service to the external apparatus 150, providing the financial service by the external apparatus 150 if the external apparatus 150 approves to provide the financial service to the user, and changing the sales price payment account information by the electronic apparatus 100. Through this, external exposure of sensitive data among predetermined information (e.g., user information, sales information, etc.) managed by the electronic apparatus 100 is minimized, and the electronic apparatus 100 may immediately inform the user of whether or not a financial service can be provided.

Meanwhile, unlike as shown in FIG. 5, in the method of providing a financial service according to yet another example embodiment, it is possible that the electronic apparatus 100 providing an e-commerce sales service transmits at least part of information related to item sales and user information to the external apparatus 150, and, based on the provided information, the external apparatus 150 determines the conditions for providing financial services and whether to approve the provision. When the user is approved to be provided with the financial service, the external apparatus 150 provides the financial service, while the electronic apparatus 100 changes and sets the financial account (sales price payment account) information to pay the sales price to be settled according to the provision of the e-commerce sales service to the user.

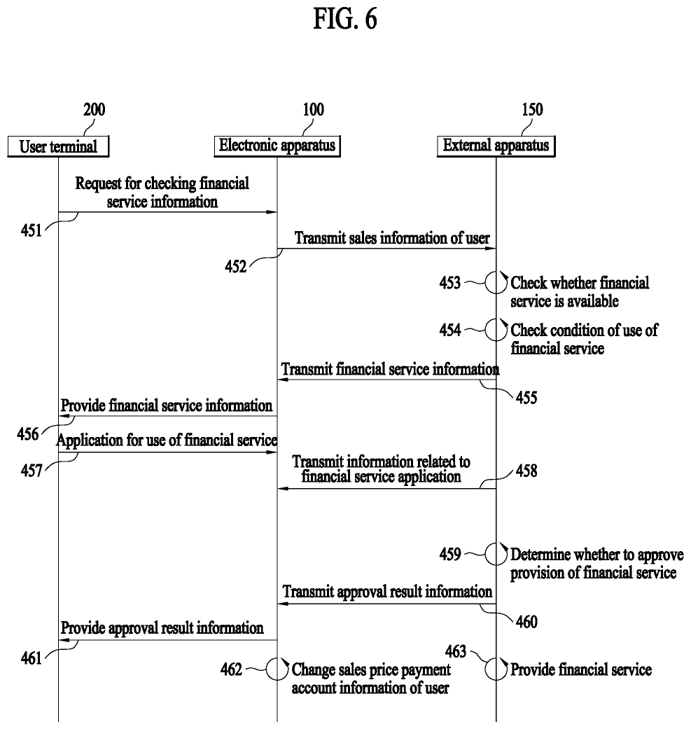

For example, referring to FIG. 6, in the method of providing a financial service according to an example embodiment, in operation 451, user input information for requesting checking of financial service information from the user terminal 200 is received by the electronic apparatus 100.

However, the method of providing a financial service according to various example embodiments of the present invention is not limited to this example, and the user input information regarding the request for checking the financial service information transmitted from the user terminal 200 may be received through the external apparatus 150, as shown in operation 411 of FIG. 4. In this case, the external apparatus 150 may transmit user information (e.g., user identification information, etc.) corresponding to the user input to the electronic apparatus 100 to check the financial service information as in operation 412 of FIG. 4.

In operation 452 of FIG. 6, the electronic apparatus 100 may transmit the user's sales-related information to the external apparatus 150 based on the information received from the user terminal 200 (or the external apparatus 150). At this time, the sales-related information transmitted to the external apparatus 150 may include at least some of existing sales history information, attribute information of sale items, category information of sale items, sales history information of another user corresponding to the category, use history information of financial services of the another user, information on whether the user has subscribed to a sales-related membership (or membership level), unsettled sales information to be paid from the electronic apparatus 100 (e.g., sales figures, settlement schedule information corresponding to each sales figures (e.g., settlement type information regarding whether the weekly settlement schedule or the monthly settlement schedule is set).

Referring to FIG. 6, according to a method for providing a financial service according to an example embodiment, in operations 453 and 454, it may be checked, on the external apparatus 150, whether the user is eligible for a financial service, and, if the user is eligible, information on conditions of use (limit, period, interest rate, etc.) of the financial service, based on the user's sales-related information received from the electronic apparatus 100. In operations 455 and 456, the checked result information (financial service-related information) may be provided to the user by at least one of the electronic apparatus 100 and the user terminal 200.

In operations 457 and 458, the user may request the use of the financial service through the user terminal 200 with reference to the check result, and the user input regarding the application for use of the financial service may be transmitted from the user terminal 200 to the electronic apparatus 100 and then transmitted from the electronic apparatus 100 to the external apparatus 150, or may be transmitted from the user terminal 200 directly to the external apparatus 150.

Meanwhile, the electronic apparatus 100 may provide and update unsettled sales information corresponding to the user to the external apparatus 150 together with the user input related to the application for the financial service. Alternatively, the electronic apparatus 100 may periodically update the unsettled sales information corresponding to the user to the external apparatus 150 regardless of transmission of the user input related to the financial service application.

In operation 459, the external apparatus 150 may determine whether to finally approve to provide the financial service to the user based on the user input related to the application for the financial service. For example, the external apparatus 150 may determine whether to finally approve by checking whether the financial service use application condition (e.g., application amount limit, application period condition, application interest rate condition, etc.) included in the user input is within the range of the financial service use condition corresponding to the user determined in operation 454. In addition, the external apparatus 150 may additionally calculate the financial service use condition based on the unsettled sales information for the user, which is periodically updated, and determine whether to finally approve.

In operations 460 and 461, the external apparatus 150 may transmit the information related to the approval result to the electronic apparatus 100 and the user terminal 200. If it is approved to provide a financial service to the user, based on the approval confirmation information, in operation 463, the external apparatus 150 may generate instruction information to provide a financial service to the user, and in operation 462, the electronic apparatus 100 may change the financial account (sales price payment account) information to a virtual account of the external apparatus 150.

Example embodiments of the present disclosure have been disclosed in the present specification and drawings. Although specific terms are used, these are only used in general meaning to easily explain the technical content of the present disclosure and to aid understanding of the present disclosure, but not intended to limit the scope of the present disclosure. It is obvious to those skilled in the art that other modified examples based on the technical idea of the present disclosure can be implemented in addition to the example embodiments disclosed herein.

The electronic apparatus or user terminal according to the above-described example embodiments may include a processor, a memory for storing and executing program data, a permanent storage such as a disk drive, a communication port for communicating with an external device, a user interface device such as a touch panel, a key, a button, or the like. Methods implemented as software modules or algorithms may be stored on a computer-readable recording medium as computer-readable codes or program instructions executable on the processor. Here, the computer-readable recording medium includes a magnetic storage medium (e.g., ROM (read-only memory), RAM (random-Access memory), floppy disk, hard disk, etc.) and optical reading medium (e.g., CD-ROM and DVD (Digital Versatile Disc)). The computer-readable recording medium is distributed over networked computer systems, so that computer-readable codes can be stored and executed in a distributed manner. The medium is readable by a computer, stored in a memory, and executed on a processor.

The present example embodiment can be represented by functional block configurations and various processing steps. These functional blocks may be implemented with various numbers of hardware or/and software configurations that perform specific functions. For example, the example embodiment may employ an integrated circuit configuration such as memory, processing, logic, look-up table, or the like, capable of executing various functions by control of one or more microprocessors or other control devices. Similar to that components can be implemented with software programming or software elements, this example embodiment includes various algorithms implemented with a combination of data structures, processes, routines or other programming components and may be implemented with a programming or scripting language including C, C++, Java, assembler, etc. Functional aspects can be implemented with an algorithm running on one or more processors. In addition, the present example embodiment may employ a conventional technique for at least one of electronic environment setting, signal processing, and data processing. Terms such as “mechanism”, “element”, “means”, and “composition” can be used in a broad sense, and are not limited to mechanical and physical configurations. Those terms may include the meaning of a series of routines of software in connection with a processor or the like.

The above-described example embodiments are merely examples, and other embodiments may be implemented within the scope of the claims to be described later.

What is claimed is:

1. A financial service providing method of an electronic apparatus, the method comprising:
checking whether a financial service is available for a user based on the user's first sales information;
checking a condition of use of the financial service for the user based on the user's second sales information;
providing information on whether the financial service is available and the condition of use to an external apparatus;
providing unsettled sales information of the user based on an information request from the external apparatus; and
changing payment account information of a sales price to be paid to the user based on receiving information related to approval of providing the financial service from the external apparatus.

2. The financial service providing method of claim 1, wherein the financial service includes a service provided by changing a payment schedule of at least a portion of the sales price to be paid to the user in connection with the external apparatus, and
the method further comprises generating instruction information, based on the generation of instruction information for paying at least a portion of the sales price to the sales price payment account before the change according to the changed payment schedule on the external apparatus, to pay the at least a portion of the sales price to the changed sales price payment account according to the payment schedule before the change on the electronic apparatus.

3. The financial service providing method of claim 2, wherein the instruction information for paying the at least a portion of the sales price according to the changed payment schedule on the external apparatus includes instruction information to pay at least a portion of the sales price increased or decreased in response to the changed payment schedule.

4. The financial service providing method of claim 1, wherein the changing of the payment account information of the sales price comprises changing a virtual account of the user corresponding to the external apparatus to the sales price payment account.

5. The financial service providing method of claim 1, wherein the checking whether the financial service is available comprises checking whether the financial service is available for the user based on the user's sales period information and existing sales figures information included in the first sales information.

6. The financial service providing method of claim 1, wherein the checking whether the financial service is available comprises checking whether the financial service is available for the user based on return rate information of at least one item belonging to a category of a sale item included in the first sales information.

7. The financial service providing method of claim 1, wherein the checking whether the financial service is available comprises checking whether the financial service is available for the user based on financial service use history information of other users who sell at least one item belonging to a category of a sale item included in the first sales information.

8. The financial service providing method of claim 1, wherein the checking of the condition of use of the financial service comprises determining the condition of use of the financial service for the user based on category information and sales figures information of a sale item included in the second sales information.

9. The financial service providing method of claim 1, further comprising updating the user's unsettled sales information at intervals of a preset time period.

10. The financial service providing method of claim 1, wherein the condition of use of the financial service includes a condition for payment limit of the sales price, a condition related to a payment schedule of the sales price, and an interest rate condition.

11. The financial service providing method of claim 1, wherein the financial service includes provision of an event that allows a use of a card corresponding to the sales price to be provided to the user.

12. The financial service providing method of claim 1, wherein the checking of the condition of use of the financial service comprises determining the condition of use of the financial service for the user based on whether the user has subscribed to a sales-related membership.

13. An electronic apparatus comprising:
a communication module;
a database; and
a processor electrically connected to the database,
wherein the processor is set to:
check whether a financial service is available for a user based on the user's first sales information;
check a condition of use of the financial service for the user based on the user's second sales information;
transmit instruction information requesting provision of the financial service to an external apparatus based on a user input; and
change sales price payment account information of the user based on receiving information related to approval of the provision of the financial service from the external apparatus.

14. The electronic apparatus of claim 13, wherein the first sales information includes at least one of return rate information and financial service history information related to sales of another user who sells at least one item belonging to the user's sale item category.

15. The electronic apparatus of claim 13, wherein the processor is set to check a condition related to a financial service use limit and an interest rate corresponding to category information of the user's sale item included in the second sales information.
